(19) United States
(12) Patent Application Publication
(10) Pub. No.: US 2020/0349526 A1
(43) Pub. Date: Nov. 5, 2020

(54) METHOD FOR ARRANGING MEETING AGENDA AND COMPUTER DEVICE EMPLOYING THE SAME

(71) Applicant: NANNING FUGUI PRECISION INDUSTRIAL CO., LTD., Nanning (CN)

(72) Inventors: YOU-WEI TENG, New Taipei (TW); KO-LO CHEN, New Taipei (TW)

(21) Appl. No.: 16/398,738

(22) Filed: Apr. 30, 2019

(51) Int. Cl. G06Q 10/10; G06Q 10/04; G06Q 10/06

(52) U.S. Cl. CPC G06Q 10/1095; G06Q 10/063116; G06Q 10/04

(57) ABSTRACT

A method applied in a computing device for arranging a meeting agenda includes obtaining combinations of m agenda items by applying permutations and combinations to the m agenda items. Partial combinations from all combinations of the m agenda items are determined. Once score values of each of the partial combinations are calculated, and combinations are selected from the partial combinations, the selected combinations are output as the meeting agenda. The present disclosure can optimize the arrangement of the meeting agenda to save time for participants of a meeting.

### FIELD

The present disclosure relates to data processing technologies, in particular to a method for arranging a meeting agenda and a computer device employing the same.

### BACKGROUND

Remote meeting websites, such as Webex and ZOOM, can allow multiple people to participate in an online meeting at the same time. Sometimes, a meeting with many participants may last for hours. However, some participants of the meeting may only need to participate in some agenda items of the meeting. Therefore, it is necessary to make a reasonable arrangement for agenda items of the meeting to save time for the participants of the meeting.

### BRIEF DESCRIPTION OF THE DRAWINGS

FIG. 1 shows a flow chart of one embodiment of a method for arranging an agenda of a meeting of the present disclosure.

FIG. 2A shows a relationship between agenda items of a meeting and participants of the meeting.

FIG. 2B shows personal information corresponding to respective weight values.

FIG. 2C shows an example of processing combinations of the agenda items of the meeting.

FIG. 3 shows one embodiment of modules of a meeting agenda arrangement system of the present disclosure.

FIG. 4 shows one embodiment of a schematic structural diagram of a computer device of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

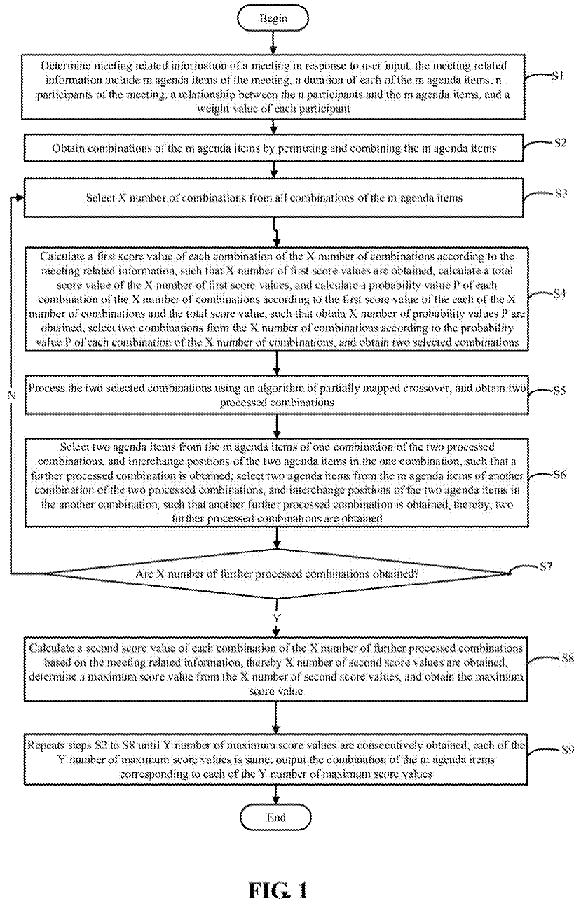

FIG. 1 shows a flow chart of one embodiment of a method for arranging a meeting agenda of the present disclosure.

In one embodiment, the meeting agenda arrangement method can be applied to a computer device. For a computer device that needs to perform a meeting agenda arrangement, the function for arranging the meeting agenda provided by the method of the present disclosure can be directly integrated on the computer device, or run on the computer device in the form of a software development kit (SDK).

As shown in FIG. 1, the meeting agenda arrangement method according to the embodiment of the present disclosure includes the following steps:

S1, the computer device can determine meeting related information of a meeting in response to user input. In at least one embodiment, the meeting related information can include, but is not limited to, m agenda items of the meeting, a duration of each of the m agenda items, n participants of the meeting (i.e., the meeting includes n participants in total), a relationship between the n participants and the m agenda items, and a weight value of each of the n participant.

In at least one embodiment, m is a positive integer greater than 1, and n is a positive integer greater than or equal to 1.

In at least one embodiment, the computer device provides a user interface for a user (e.g., a moderator of the meeting) to input the m agenda items of the meeting, the duration of each of the m agenda items, the n participants of the meeting, and the participants corresponding to each agenda item.

It should be noted that each agenda item relates to a topic of the meeting.

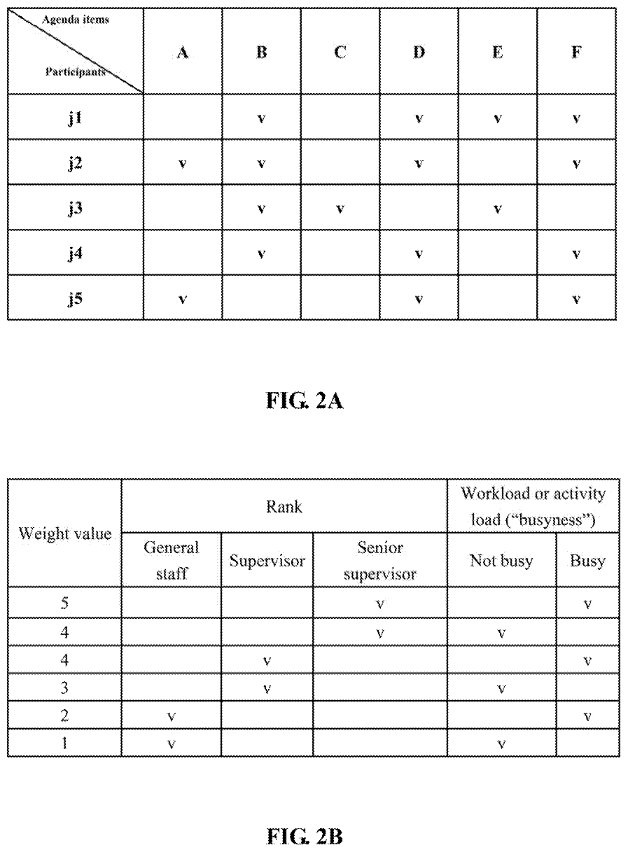

For example, as shown in FIG. 2A, the computer device determines six agenda items in response to user input, i.e., m is equal to 6. The six agenda items include A, B, C, D, E, and F. The computer device determines that there are five participants of the meeting in total, i.e., n is equal to 5. The five participants are j1, j2, j3, j4, and j5. Participants j1 and j2 correspond to agenda item A, i.e., participants j1 and j2 need to participate in agenda item A. Participants j1, j2, j3, and j4 correspond to agenda item B, i.e., participants j1, j2, j3, and j4 need to participate in agenda item B.

In at least one embodiment, the computer device can preset a reference table, and can determine the weight value of each of the n participants by searching the reference table according to personal information of each of the n participants. The reference table defines different personal information corresponding to different weight values. In at least one embodiment, the personal information of each participant can include, but is not limited to, a rank of the participant, and workload or activity load (“busyness”) of the participant. In at least one embodiment, the computer device can determine the personal information of each participant in response to user input. In other words, the computer device can determine the weight value of each participant by searching the reference table according the personal information of each participant input by the user.

For example, as show in FIG. 2B, participant j2 is a supervisor, and the participant j2 is busy, then the weight value of participant j2 can be equal to 4.

The reference table shown in FIG. 2B is an example to describe different personal information corresponding to different weight values. In other embodiments, the weight value of each participant can be determined further based on a time zone of a participant's location, and other personal information.

In other embodiments, the computer device can determine the weight value of each participant in response to user input, i.e., the weight value of each participant can be input by the user.

S2, the computer device can obtain combinations of the m agenda items by permutations and combinations of the m agenda items.

For example, if m is equal to 6, then the computer device can apply permutations and combinations of the 6 agenda items, and obtain 720 combinations in total. The number 720 is a product of 6*5*4*3*2*1.

S3, the computer device can select X number of combinations from all combinations of the m agenda items.

In at least one embodiment, X can be a positive integer that can be preset by the computer device. For example, X can be equal to 20, 30, or other positive integer.

In at least one embodiment, the computer device can select the X number of combinations from all combinations of the m agenda items in randomly.

S4, the computer device can calculate a score value (for conveniently describe the present disclosure, hereinafter “first score value”) for each of the X number of combinations according to the meeting related information, such that the computer device can obtain X number of first score values. The computer device can calculate a total score value of the X number of first score values, and can calculate a probability value P of each combination of the X number of combinations according to the first score value of the each combination and the total score value, such that the computer device can obtain X number of probability values P. The computer device can select two combinations from the X number of combinations according to the probability value P of each combination of the X number of combinations, and obtain two selected combinations.

In at least one embodiment, the first score value of each combination can be calculated using the following first formula:

$$f = {\sum }_{j = 1}^{n} {I}_{j} * {C}_{j}^{2}$$

wherein, j represents each participant of the combination, n represents the total number of participants relevant to (i.e., to be included for) the combination, Iⱼ represents the weight value of each participant, and Cⱼ represents a longest continuous duration of each participant participating in the meeting.

In at least one embodiment, the computer device calculates the longest continuous duration of any one participant according to agenda items in which the one participant is to participate, the duration of each agenda item in which the one participant is to participate, and an order of the m agenda items in the combination.

The following is an example of calculating the first score value of each combination.

As shown in FIG. 2A, there is a combination [ABCDEF], i.e., the combination includes six agenda items, A, B, C, D, E, and F, the six agenda items are ordered as A, B, C, D, E, F. The duration of each agenda item is 10 minutes. There are five participants for these six agenda items, and the five participants are j1 [symbol] j2 [symbol] j3 [symbol] j4, [symbol] and j5. The longest continuous duration of participant j1 participating in the meeting equals 30 minutes, i.e., a sum of the durations of agenda items D, E, and F in which the participant j1 is to participate. Similarly, the longest continuous duration of the participant j2 participating the meeting equals 20 minutes. The longest continuous duration of the participant j3 participating the meeting equals 20 minutes. The longest continuous duration of the participant j4 participating the meeting equals 10 minutes. The longest continuous duration of the participant j5 is 10 minutes. That is, Cⱼ=[3, 2, 2, 1, 1]. To simplify the calculation, the longest continuous duration corresponding to each participant is scaled down in same proportions. Additionally, it is assumed that the weight value of participant j1 equals 5, the weight value of participant j2 equals 4, the weight value of participant j3 equals 3, the weight value of participant j4 equals 2, and the weight value of participant j5 equals 1. That is, Iⱼ=[5, 4, 2, 3, 1]. The first score value of the combination [ABCDEF] is thus equal to 73.

wherein, i represents a combination, X represents the total number of combinations, and fᵢ represents the score value of the combination.

In at least one embodiment, the selecting of the two combinations from the X number of combinations according the probability value P of each combination of the X number of combinations includes: first sorting the X number of probability values P in a descending order; determining two probability values P that are arranged preceding to other probability values P of the X number of probability values P; and selecting the combinations corresponding to each of the two probability values P from the X number of combinations, such that two selected combinations are obtained.

S5, the computer device can process the two selected combinations using an algorithm of partially mapped crossover, and obtain two processed combinations.

In at least one embodiment, the processing of the two selected combinations using an algorithm of partially mapped crossover, and the obtaining of two processed combinations include steps (a1)-(a2):

To describe conveniently, the two selected combinations are named a first combination and a second combination.

(a1), randomly selecting two agenda items from the first combination and setting the two agenda items as cut-off points; determining agenda items of the first combination which located between the two cut-off points as first agenda items; determining agenda items of the second combination which are corresponding to the first agenda items as second agenda items; and interchanging the first agenda items with the second agenda items.

In at least one embodiment, a position of the second agenda items in the second combination is same as a position of the first agenda items in the first combination.

For example, as shown in FIG. 2C, the position of the agenda item C of combination C1 is same as the position of the agenda item E of combination C2. Similarly, the position of the agenda item D of combination C1 is same as the position of the agenda item F of combination C2.

For example, as shown in FIG. 2C, it is assumed that the two selected combinations include combinations C1 and C2, i.e., [ABCDEF] and [ACEFDB]. It is assumed that agenda items B and E of combination C1 are selected as the cut-off points, then the agenda items C and D of the combination C1 which are located between the two cut-off points (i.e., agenda items B and E) are determined as first agenda items, the agenda items E and F of the second combination which respectively correspond to the first agenda items (i.e., agenda items C and D) are determined as the second agenda items. After the interchange of the first agenda items (i.e., agenda items C and D) and the second agenda items (i.e., agenda items E and F), combinations C11 and C21 (i.e., [ABEFEF] and [ACCDDB]) are obtained.

(a2), after the interchange of the first and second agenda items, making deduplication to the two combinations (i.e., apply elimination of redundant data to the two combination), such that the two processed combinations are obtained.

For example, as shown in FIG. 2C, after the interchange of the first and second agenda items, two combinations, C11 and C21, are obtained, i.e., the combinations [ABEFEF] and [ACCDDB]. In combination C11, i.e., [ABEFEF], duplicate agenda items E and F exist. The duplicate agenda items E in the combination C11 includes agenda item E which is originally from a mother combination of the combination C11 (i.e., from combination C1) and also an agenda item E from combination C2 (not originally from the mother combination of the combination C11). Duplicate agenda items F in the combination C11 includes one agenda item F which is originally from the mother combination of the combination C11, and another agenda item F from combination C2 (not originally from the mother combination of the combination C11). The agenda items E and F originally from the mother combination of the combination C11 are respectively replaced by C and D in the process of deduplication, and a processed combination C12, i.e., [ABEFCD] is obtained. Similarly, in combination C21, i.e., [ACCDDB], duplicate agenda items C and D exist. The duplicate agenda item C in the combination C21 includes one agenda item C originally from a mother combination of the combination C21 (i.e., from combination C2), and another agenda item C from combination C1, not originally from the mother combination of the combination C21. The duplicate agenda items D includes one agenda item D originally from the mother combination of the combination C21, and another agenda item D from combination C1, not originally from the mother combination of the combination C21. Agenda items C and D originally from the mother combination C21 are respectively replaced by agenda items E and F, and processed combination C22, i.e., [AECDFB] is thereby obtained. Therefore, the two processed combinations (i.e., [ACCDDB] and [AECDFB]) are thus obtained

S6, the computer device can select two agenda items from the m agenda items of one combination of the two processed combinations, and can interchange positions of the two agenda items in the one combination, such that a further processed combination is obtained. The computer device can select two agenda items from the m agenda items of another combination of the two processed combinations, and can interchange positions of the two agenda items in the another combination, such that another further processed combination is obtained. Thereby, two further processed combinations are obtained.

In at least one embodiment, the computer device can randomly select the two agenda items from the m agenda items of each combination of the two processed combinations.

For example, it is assumed that two agenda items A and F are selected from the six agenda items of the combination C12, i.e., [ABEFCD] in random. The computer device can interchange the positions of the agenda items A and F in the combination C12, i.e., [ABEFCD], and obtain the combination [FBEACD].

S7, the computer device can determine whether or not X number of further processed combinations have been obtained. When the computer device has obtained X number of further processed combinations, the process goes to S8. When the computer device has not obtained X number of further processed combinations, the process goes to S3.

In at least one embodiment, X is a multiple of 2. For example, X can be equal to 20.

S8, when the computer device has obtained X number of further processed combinations, the computer device can calculate a score value (to describe conveniently, hereinafter named as “second score value”) of each combination of the X number of further processed combinations based on the meeting related information, thereby X number of second score values are obtained. The computer device determines a maximum score value from the X number of second score values, and obtains the maximum score value from the X number of second score values.

In at least one embodiment, the steps of calculating the second score of each combination of the X number of further processed combinations based on the meeting related information includes (b1)-(b2).

(b1), the computer device can determine whether any one combination of the X number of further processed combinations meets a predetermined condition.

In at least one embodiment, the predetermined condition includes that an order between two or more agenda items of the m agenda items of the combination is different from a predetermined order, arrangement time corresponding to a certain agenda item of the m agenda items of the combination is unavailable time of the participant participating the certain agenda item, and/or a combination thereof.

It should be noted that the certain agenda item can be any one agenda item of the m agenda items.

(b2), the computer device can set the second score value of each combination of the X number of combinations that meets the predetermined condition to be 0. The computer device can calculate the second value of each combination of the X number of combinations that does not meet the predetermined condition using the first formula based on the meeting related information.

For example, agenda item A should be ordered before agenda item B. It is assumed that the X number of further processed combinations includes a combination [BCDEAF], then the computer device sets the second score value of the combination [BCDEAF] to be 0 because the agenda item A is not before agenda item B.

S9, the computer device repeats steps S2 to S8 until the computer device consecutively obtains Y number of maximum score values, and each of the Y number of maximum score values is same. The computer device outputs the combination of the m agenda items corresponding to each of the Y number of maximum score values.

In at least one embodiment, Y is a positive integer. For example, Y equals 3, 5, or another positive integer. For example, when Y equals 3, and the computer device repeats steps S2 to S8 and consecutively obtains 3 maximum score values, and each of the 3 maximum score values is same. The computer device then outputs the combination of the m agenda items corresponding to each of the 3 maximum score values. Therefore, the user can select one of the 3 combinations as the meeting agenda.

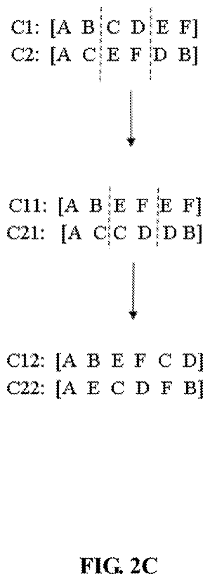

FIG. 3 shows an embodiment of modules of a meeting agenda arrangement system of the present disclosure.

In some embodiments, the meeting agenda arrangement system 30 runs in a computer device. The meeting agenda arrangement system 30 can include a plurality of modules. The plurality of modules can comprise computerized instructions in a form of one or more computer-readable programs that can be stored in a non-transitory computer-readable medium (e.g., a storage device of the computer device), and executed by at least one processor of the computer device to implement meeting agenda arrangement function (described in detail in FIG. 1).

In at least one embodiment, the meeting agenda arrangement system 30 can include a plurality of modules. The plurality of modules can include, but is not limited to a determining module 301 and an executing module 302. The modules 310-302 can comprise computerized instructions in the form of one or more computer-readable programs that can be stored in the non-transitory computer-readable medium (e.g., the storage device of the computer device), and executed by the at least one processor of the computer device to implement meeting agenda arrangement function (e.g., described in detail in FIG. 1).

The determining module 301 can determine meeting related information of a meeting in response to user input. In at least one embodiment, the meeting related information can include, but is not limited to, m agenda items of the meeting, a duration of each of the m agenda items, n participants of the meeting (i.e., the meeting includes n participants in total), a relationship between the n participants and the m agenda items, and a weight value of each of the n participant.

In at least one embodiment, m is a positive integer greater than 1, and n is a positive integer greater than or equal to 1.

In at least one embodiment, the determining module 301 provides a user interface for a user (e.g., a moderator of the meeting) to input the m agenda items of the meeting, the duration of each of the m agenda items, the n participants of the meeting, and the participants corresponding to each agenda item.

It should be noted that each agenda item relates to a topic of the meeting.

For example, as shown in FIG. 2A, the determining module 301 determines six agenda items in response to user input, i.e., m is equal to 6. The six agenda items include A, B, C, D, E, and F. The determining module 301 determines that there are five participants of the meeting in total, i.e., n is equal to 5. The five participants are j1, j2, j3, j4, and j5. Participants j1 and j2 correspond to agenda item A, i.e., participants j1 and j2 need to participate in agenda item A. Participants j1, j2, j3, and j4 correspond to agenda item B, i.e., participants j1, j2, j3, and j4 need to participate in agenda item B.

In at least one embodiment, the determining module 301 can preset a reference table, and can determine the weight value of each of the n participants by searching the reference table according to personal information of each of the n participants. The reference table defines different personal information corresponding to different weight values. In at least one embodiment, the personal information of each participant can include, but is not limited to, a rank of the participant, and workload or activity load (“busyness”) of the participant. In at least one embodiment, the determining module 301 can determine the personal information of each participant in response to user input. In other words, the determining module 301 can determine the weight value of each participant by searching the reference table according the personal information of each participant input by the user.

For example, as show in FIG. 2B, participant j2 is a supervisor, and the participant j2 is busy, then the weight value of participant j2 can be equal to 4.

The reference table shown in FIG. 2B is an example to describe different personal information corresponding to different weight values. In other embodiments, the weight value of each participant can be determined further based on a time zone of a participant's location, and other personal information.

In other embodiments, the determining module 301 can determine the weight value of each participant in response to user input, i.e., the weight value of each participant can be input by the user.

The executing module 302 can obtain combinations of the m agenda items by permutations and combinations of the m agenda items.

For example, if m is equal to 6, then the executing module 302 can apply permutations and combinations of the 6 agenda items, and obtain 720 combinations in total. The number 720 is a product of 6*5*4*3*2*1.

The executing module 302 can select X number of combinations from all combinations of the m agenda items.

In at least one embodiment, X can be a positive integer that can be preset by the executing module 302e. For example, X can be equal to 20, 30, or other positive integer.

In at least one embodiment, the executing module 302 can select the X number of combinations from all combinations of the m agenda items in randomly.

The executing module 302 can calculate a score value (for conveniently describe the present disclosure, hereinafter “first score value”) for each of the X number of combinations according to the meeting related information, such that the executing module 302 can obtain X number of first score values. The executing module 302 can calculate a total score value of the X number of first score values, and can calculate a probability value P of each combination of the X number of combinations according to the first score value of the each combination and the total score value, such that the executing module 302 can obtain X number of probability values P. The executing module 302 can select two combinations from the X number of combinations according to the probability value P of each combination of the X number of combinations, and obtain two selected combinations.

In at least one embodiment, the first score value of each combination can be calculated using the following first formula:

$$f = {\sum }_{j = 1}^{n} {I}_{j} * {C}_{j}^{2}$$

wherein, j represents each participant of the combination, n represents the total number of participants relevant to (i.e. to be included for) the combination, Iⱼ represents the weight value of each participant, and Cⱼ represents a longest continuous duration of each participant participating in the meeting.

In at least one embodiment, the executing module 302 calculates the longest continuous duration of any one participant according to agenda items in which the one participant is to participate, the duration of each agenda item in which the one participant is to participate, and an order of the m agenda items in the combination.

The following is an example of calculating the first score value of each combination.

As shown in FIG. 2A, there is a combination [ABCDEF], i.e., the combination includes six agenda items, A, B, C, D, E, and F, the six agenda items are ordered as A, B, C, D, E, F. The duration of each agenda item is 10 minutes. There are five participants for these six agenda items, and the five participants are j1 [symbol] j2 [symbol] j3 [symbol] j4, [symbol] and j5. The longest continuous duration of participant j1 participating in the meeting equals 30 minutes, i.e., a sum of the durations of agenda items D, E, and F in which the participant j1 is to participate. Similarly, the longest continuous duration of the participant j2 participating the meeting equals 20 minutes. The longest continuous duration of the participant j3 participating the meeting equals 20 minutes. The longest continuous duration of the participant j4 participating the meeting equals 10 minutes. The longest continuous duration of the participant j5 is 10 minutes. That is, Cⱼ=[3, 2, 2, 1, 1]. To simplify the calculation, the longest continuous duration corresponding to each participant is scaled down in same proportions. Additionally, it is assumed that the weight value of participant j1 equals 5, the weight value of participant j2 equals 4, the weight value of participant j3 equals 3, the weight value of participant j4 equals 2, and the weight value of participant j5 equals 1. That is, Iⱼ=[5, 4, 2, 3, 1]. The first score value of the combination [ABCDEF] is thus equal to 73.

wherein, i represents a combination, X represents the total number of combinations, and fᵢ represents the score value of the combination.

In at least one embodiment, the selecting of the two combinations from the X number of combinations according the probability value P of each combination of the X number of combinations includes: first sorting the X number of probability values P in a descending order; determining two probability values P that are arranged preceding to other probability values P of the X number of probability values P; and selecting the combinations corresponding to each of the two probability values P from the X number of combinations, such that two selected combinations are obtained.

The executing module 302 can process the two selected combinations using an algorithm of partially mapped crossover, and obtain two processed combinations.

In at least one embodiment, the processing of the two selected combinations using an algorithm of partially mapped crossover, and the obtaining of two processed combinations include steps (a1)-(a2):

To describe conveniently, the two selected combinations are named a first combination and a second combination.

(a1), randomly selecting two agenda items from the first combination and setting the two agenda items as cut-off points; determining agenda items of the first combination which located between the two cut-off points as first agenda items; determining agenda items of the second combination which are corresponding to the first agenda items as second agenda items; and interchanging the first agenda items with the second agenda items.

In at least one embodiment, a position of the second agenda items in the second combination is same as a position of the first agenda items in the first combination.

For example, as shown in FIG. 2C, the position of the agenda item C of combination C1 is same as the position of the agenda item E of combination C2. Similarly, the position of the agenda item D of combination C1 is same as the position of the agenda item F of combination C2.

For example, as shown in FIG. 2C, it is assumed that the two selected combinations include combinations C1 and C2, i.e., [ABCDEF] and [ACEFDB]. It is assumed that agenda items B and E of combination C1 are selected as the cut-off points, then the agenda items C and D of the combination C1 which are located between the two cut-off points (i.e., agenda items B and E) are determined as first agenda items, the agenda items E and F of the second combination which respectively correspond to the first agenda items (i.e., agenda items C and D) are determined as the second agenda items. After the interchange of the first agenda items (i.e., agenda items C and D) and the second agenda items (i.e., agenda items E and F), combinations C11 and C21 (i.e., [ABEFEF] and [ACCDDB]) are obtained.

(a2), after the interchange of the first and second agenda items, making deduplication to the two combinations (i.e., apply elimination of redundant data to the two combination), such that the two processed combinations are obtained.

For example, as shown in FIG. 2C, after the interchange of the first and second agenda items, two combinations, C11 and C21, are obtained, i.e., the combinations [ABEFEF] and [ACCDDB]. In combination C11, i.e., [ABEFEF], duplicate agenda items E and F exist. The duplicate agenda items E in the combination C11 includes agenda item E which is originally from a mother combination of the combination C11 (i.e., from combination C1) and also an agenda item E from combination C2 (not originally from the mother combination of the combination C11). Duplicate agenda items F in the combination C11 includes one agenda item F which is originally from the mother combination of the combination C11, and another agenda item F from combination C2 (not originally from the mother combination of the combination C11). The agenda items E and F originally from the mother combination of the combination C11 are respectively replaced by C and D in the process of deduplication, and a processed combination C12, i.e., [ABEFCD] is obtained. Similarly, in combination C21, i.e., [ACCDDB], duplicate agenda items C and D exist. The duplicate agenda item C in the combination C21 includes one agenda item C originally from a mother combination of the combination C21 (i.e., from combination C2), and another agenda item C from combination C1, not originally from the mother combination of the combination C21. The duplicate agenda items D includes one agenda item D originally from the mother combination of the combination C21, and another agenda item D from combination C1, not originally from the mother combination of the combination C21. Agenda items C and D originally from the mother combination C21 are respectively replaced by agenda items E and F, and processed combination C22, i.e., [AECDFB] is thereby obtained. Therefore, the two processed combinations (i.e., [ACCDDB] and [AECDFB]) are thus obtained

The executing module 302 can select two agenda items from the m agenda items of one combination of the two processed combinations, and can interchange positions of the two agenda items in the one combination, such that a further processed combination is obtained. The executing module 302 can select two agenda items from the m agenda items of another combination of the two processed combinations, and can interchange positions of the two agenda items in the another combination, such that another further processed combination is obtained. Thereby, two further processed combinations are obtained.

In at least one embodiment, the executing module 302 can randomly select the two agenda items from the m agenda items of each combination of the two processed combinations.

For example, it is assumed that two agenda items A and F are selected from the six agenda items of the combination C12, i.e., [ABEFCD] in random. The executing module 302 can interchange the positions of the agenda items A and F in the combination C12, i.e., [ABEFCD], and obtain the combination [FBEACD].

The executing module 302 can determine whether or not X number of further processed combinations have been obtained. In at least one embodiment, X is a multiple of 2. For example, X can be equal to 20.

When the executing module 302 has obtained X number of further processed combinations, the executing module 302 can calculate a score value (to describe conveniently, hereinafter named as “second score value”) of each combination of the X number of further processed combinations based on the meeting related information, thereby X number of second score values are obtained. The executing module 302 determines a maximum score value from the X number of second score values, and obtains the maximum score value from the X number of second score values.

In at least one embodiment, the steps of calculating the second score of each combination of the X number of further processed combinations based on the meeting related information includes (b1)-(b2).

(b1), the executing module 302 can determine whether any one combination of the X number of further processed combinations meets a predetermined condition.

In at least one embodiment, the predetermined condition includes that an order between two or more agenda items of the m agenda items of the combination is different from a predetermined order, arrangement time corresponding to a certain agenda item of the m agenda items of the combination is unavailable time of the participant participating the certain agenda item, and/or a combination thereof.

It should be noted that the certain agenda item can be any one agenda item of the m agenda items.

(b2), the executing module 302 can set the second score value of each combination of the X number of combinations that meets the predetermined condition to be 0. The executing module 302 can calculate the second value of each combination of the X number of combinations that does not meet the predetermined condition using the first formula based on the meeting related information.

For example, agenda item A should be ordered before agenda item B. It is assumed that the X number of further processed combinations includes a combination [BCDEAF], then the executing module 302 sets the second score value of the combination [BCDEAF] to be 0 because the agenda item A is not before agenda item B.

When the executing module 302 consecutively obtains Y number of maximum score values, and each of the Y number of maximum score values is same, the executing module 302 outputs the combination of the m agenda items corresponding to each of the Y number of maximum score values.

In at least one embodiment, Y is a positive integer. For example, Y equals 3, 5, or another positive integer. For example, when Y equals 3, and the executing module 302 consecutively obtains 3 maximum score values, and each of the 3 maximum score values is same, the executing module 302 then outputs the combination of the m agenda items corresponding to each of the 3 maximum score values. Therefore, the user can select one of the 3 combinations of the m agenda items as the meeting agenda.

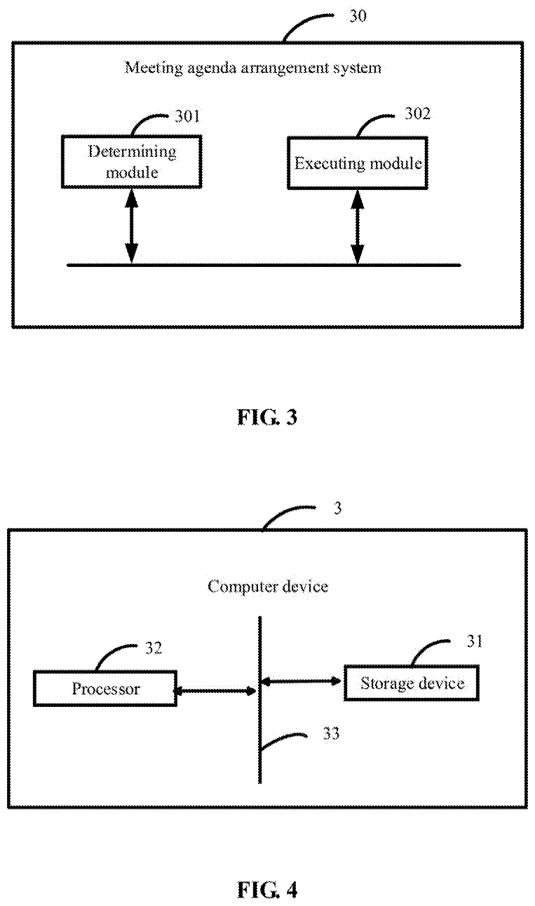

FIG. 4 shows one embodiment of a schematic structural diagram of a computer device. In an embodiment, a computer device 3 includes a storage device 31, at least one processor 32, and at least one bus 33. It should be understood by those skilled in the art that the structure of the computer device 3 shown in FIG. 4 does not constitute a limitation of the embodiment of the present disclosure. The computer device 3 may have a bus type structure or a star type structure, and the computer device 3 may further include other hardware or software, or the computer device 3 may have different component arrangements.

In at least one embodiment, the computer device 3 can include a terminal that is capable of automatically performing numerical calculations and/or information processing in accordance with pre-set or stored instructions. The hardware of terminal can include, but is not limited to, a microprocessor, an application specific integrated circuit, programmable gate arrays, digital processors, and embedded devices.

It should be noted that the computer device 3 is merely an example, and other existing or future electronic products may be included in the scope of the present disclosure, and are included in the reference.

In some embodiments, the storage device 31 can be used to store program codes of computer readable programs and various data, such as the meeting agenda arrangement system 30 installed in the computer device 3, and automatically access to the programs or data with high speed during running of the computer device 3. The storage device 31 can include a read-only memory (ROM), a random access memory (RAM), a programmable read-only memory (PROM), an erasable programmable read only memory (EPROM), an one-time programmable read-only memory (OTPROM), an electronically-erasable programmable read-only memory (EEPROM)), a compact disc read-only memory (CD-ROM), or other optical disk storage, magnetic disk storage, magnetic tape storage, or any other storage medium readable by the computer device 3 that can be used to carry or store data.

In some embodiments, the at least one processor 32 may be composed of an integrated circuit, for example, may be composed of a single packaged integrated circuit, or may be composed of multiple integrated circuits of same function or different functions. The at least one processor 32 can include one or more central processing units (CPU), a microprocessor, a digital processing chip, a graphics processor, and various control chips. The at least one processor 32 is a control unit of the computer device 3, which connects various components of the computer device 3 using various interfaces and lines. By running or executing a computer program or modules stored in the storage device 31, and by invoking the data stored in the storage device 31, the at least one processor 32 can perform various functions of the computer device 3 and process data of the computer device 3. For example, the function of performing the meeting agenda arrangement.

In some embodiments, the bus 33 is used to achieve communication between the storage device 31 and the at least one processor 32, and other components of the compute device 3.

Although not shown, the computer device 3 may further include a power supply (such as a battery) for powering various components. Preferably, the power supply may be logically connected to the at least one processor 32 through a power management device, thereby, the power management device manages functions such as charging, discharging, and power management. The power supply may include one or more a DC or AC power source, a recharging device, a power failure detection circuit, a power converter or inverter, a power status indicator, and the like. The computer device 3 may further include various sensors, such as a BLUETOOTH module, a Wi-Fi module, and the like, and details are not described herein.

In at least one embodiment, as shown in FIG. 3, the at least one processor 32 can execute various types of applications (such as the meeting agenda arrangement system 30) installed in the computer device 3, program codes, and the like. For example, the at least one processor 32 can execute the modules 301-302 of the meeting agenda arrangement system 30.

In at least one embodiment, the storage device 31 stores program codes. The at least one processor 32 can invoke the program codes stored in the storage device to perform functions. For example, the modules described in FIG. 3 are program codes stored in the storage device 31 and executed by the at least one processor 32, to implement the functions of the various modules for the purpose of arranging meeting agenda.

In at least one embodiment, the storage device 31 stores one or more instructions (i.e., at least one instruction) that are executed by the at least one processor 32 to achieve the purpose of arranging meeting agenda.

In at least one embodiment, the at least one processor 32 can execute the at least one instruction stored in the storage device 31 to perform the operations of as shown in FIG. 1.

The steps in the method of the embodiments of the present disclosure may be sequentially adjusted, merged, and deleted according to actual needs.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A method for arranging a meeting agenda applied to a computer device, the method comprising:
determining meeting related information in response to user input, wherein the meeting related information comprises m agenda items of a meeting;
obtaining combinations of the m agenda items by permutations and combinations of the m agenda items;
selecting X number of combinations from all combinations of the m agenda items;
calculating a first score value of each combination of the X number of combinations according to the meeting related information, and obtaining X number of first score values;
calculating a total score value of the X number of first score values;
calculating a probability value P of each combination of the X number of combinations according to the first score value of the each of the X number of combinations and the total score value, and obtaining X number of probability values P;
selecting two combinations from the X number of combinations according to the probability value P of each combination of the X number of combinations, and obtaining two selected combinations;
processing the two selected combinations using a predetermined algorithm, and obtaining two processed combinations;
selecting two agenda items from the m agenda items of one combination of the two processed combinations, interchanging positions of the two agenda items in the one combination, and obtaining a further processed combination;
selecting two agenda items from the m agenda items of another combination of the two processed combinations, interchanging positions of the two agenda items in the another combination, and obtaining another further processed combination, such that two further processed combinations are obtained;
obtaining X number of further processed combinations, wherein X is a multiple of 2;
calculating a second score value of each combination of the X number of further processed combinations based on the meeting related information, thereby X number of second score values are obtained;
determining a maximum score value from the X number of second score values, and obtaining the maximum score value from the X number of second score values;
outputting the combination of the m agenda items corresponding to each of Y number of maximum score values that are consecutively obtained, wherein each of the Y number of maximum score values is same.

2. The method according to claim 1, wherein the meeting related information further comprises a duration of each of the m agenda items, n participants of the meeting, a relationship between the n participants and the m agenda items, and a weight value of each of the n participants.

3. The method according to claim 2, wherein the first score value and the second score value is calculated using a formula:
$$f = {\sum }_{j = 1}^{n} {I}_{j} * {C}_{j}^{2}$$
wherein, j represents each of the participants of the combination, n represents the total number of the participants included in the combination, Iⱼ represents the weight value of each of the participants, and Cⱼ represents a longest continuous duration of each of the participants participating the meeting.

4. The method according to claim 3, wherein the calculating of a second score value of each combination of X number of further processed combinations based on the meeting related information comprises:
setting the second score value of each combination of the X number of further processed combinations that meets a predetermined condition to be 0; and
calculating the second score value of each combination of the X number of further processed combinations that does not meet the predetermined condition, using the formula.

5. The method according to claim 4, wherein the predetermined condition comprises:
an order between two or more agenda items of the m agenda items of the combination is different from a predetermined order, arrangement time corresponding to a certain agenda item of the m agenda items of the combination is unavailable time of the participant participating the certain agenda item, and/or a combination thereof.

6. The method according to claim 2, further comprising:
presetting a reference table, wherein the reference table defines personal information corresponding to a corresponding one of the weight values; and
determining the weight value of each of the n participants by searching the reference table according to personal information of each of the n participants.

7. The method according to claim 1, wherein the processing of the two selected combinations using the predetermined algorithm comprises:
selecting two agenda items from a first combination of the two selected combinations in random;
setting the two agenda items as cut-off points;
determining agenda items of the first combination which located between the two cut-off points as first agenda items;
determining agenda items of the second combination which are corresponding to the first agenda items as second agenda items;
interchanging the first agenda items of the first combination with the second agenda items of the second combination; and
making deduplication to the first combination and the second combination, such that the two processed combinations are obtained.

8. A computer device comprising:
a storage device;
at least one processor; and
the storage device storing one or more programs, which when executed by the at least one processor, cause the at least one processor to:
determine meeting related information in response to user input, wherein the meeting related information comprises m agenda items of a meeting;
obtain combinations of the m agenda items by permutations and combinations of the m agenda items;
select X number of combinations from all combinations of the m agenda items;
calculate a first score value of each combination of the X number of combinations according to the meeting related information, and obtain X number of first score values;
calculate a total score value of the X number of first score values;
calculate a probability value P of each combination of the X number of combinations according to the first score value of the each of the X number of combinations and the total score value, and obtaining X number of probability values P;
select two combinations from the X number of combinations according to the probability value P of each combination of the X number of combinations, and obtain two selected combinations;
process the two selected combinations using a predetermined algorithm, and obtain two processed combinations;
select two agenda items from the m agenda items of one combination of the two processed combinations, interchange positions of the two agenda items in the one combination, and obtain a further processed combination;
select two agenda items from the m agenda items of another combination of the two processed combinations, interchange positions of the two agenda items in the another combination, and obtain another further processed combination, such that two further processed combinations are obtained;
obtain X number of further processed combinations, wherein X is a multiple of 2;
calculate a second score value of each combination of the X number of further processed combinations based on the meeting related information, thereby X number of second score values are obtained;
determine a maximum score value from the X number of second score values, and obtaining the maximum score value from the X number of second score values;
output the combination of the m agenda items corresponding to each of Y number of maximum score values that are consecutively obtained, wherein each of the Y number of maximum score values is same.

9. The computer device according to claim 8, wherein the meeting related information further comprises a duration of each of the m agenda items, n participants of the meeting, a relationship between the n participants and the m agenda items, and a weight value of each of the n participants.

10. The computer device according to claim 9, wherein the first score value and the second score value is calculated using a formula:
$$f = {\sum }_{j = 1}^{n} {I}_{j} * {C}_{j}^{2}$$
wherein, j represents each of the participants of the combination, n represents the total number of the participants included in the combination, Iⱼ represents the weight value of each of the participants, and Cⱼ represents a longest continuous duration of each of the participants participating the meeting.

11. The computer device according to claim 10, wherein the calculating of a second score value of each combination of X number of further processed combinations based on the meeting related information comprises:
setting the second score value of each combination of the X number of further processed combinations that meets a predetermined condition to be 0; and
calculating the second score value of each combination of the X number of further processed combinations that does not meet the predetermined condition, using the formula.

12. The computer device according to claim 11, wherein the predetermined condition comprises:
an order between two or more agenda items of the m agenda items of the combination is different from a predetermined order, arrangement time corresponding to a certain agenda item of the m agenda items of the combination is unavailable time of the participant participating the certain agenda item, and/or a combination thereof.

13. The computer device according to claim 9, wherein the calculating of the weight value of each participant comprising:
presetting a reference table, wherein the reference table defines personal information corresponding to a corresponding one of the weight values; and
determining the weight value of each of the n participants by searching the reference table according to personal information of each of the n participants.

14. The computer device according to claim 8, wherein the processing of the two selected combinations using the predetermined algorithm comprises:
selecting two agenda items from a first combination of the two selected combinations in random;
setting the two agenda items as cut-off points;
determining agenda items of the first combination which located between the two cut-off points as first agenda items;
determining agenda items of the second combination which are corresponding to the first agenda items as second agenda items;
interchanging the first agenda items of the first combination with the second agenda items of the second combination; and
making deduplication to the first combination and the second com

15. A non-transitory storage medium having instructions stored thereon, when the instructions are executed by a processor of a computer device, the processor is configured to perform a method of arranging a meeting agenda, wherein the method comprises:
determining meeting related information in response to user input, wherein the meeting related information comprises m agenda items of a meeting;
obtaining combinations of the m agenda items by permutations and combinations of the m agenda items;
selecting X number of combinations from all combinations of the m agenda items;
calculating a first score value of each combination of the X number of combinations according to the meeting related information, and obtaining X number of first score values;
calculating a total score value of the X number of first score values;
calculating a probability value P of each combination of the X number of combinations according to the first score value of the each of the X number of combinations and the total score value, and obtaining X number of probability values P;
selecting two combinations from the X number of combinations according to the probability value P of each combination of the X number of combinations, and obtaining two selected combinations;
processing the two selected combinations using a predetermined algorithm, and obtaining two processed combinations;
selecting two agenda items from the m agenda items of one combination of the two processed combinations, interchanging positions of the two agenda items in the one combination, and obtaining a further processed combination;
selecting two agenda items from the m agenda items of another combination of the two processed combinations, interchanging positions of the two agenda items in the another combination, and obtaining another further processed combination, such that two further processed combinations are obtained;
obtaining X number of further processed combinations, wherein X is a multiple of 2;
calculating a second score value of each combination of the X number of further processed combinations based on the meeting related information, thereby X number of second score values are obtained;
determining a maximum score value from the X number of second score values, and obtaining the maximum score value from the X number of second score values;
outputting the combination of the m agenda items corresponding to each of Y number of maximum score values that are consecutively obtained, wherein each of the Y number of maximum score values is same.

16. The non-transitory storage medium according to claim 15, wherein the meeting related information further comprises a duration of each of the m agenda items, n participants of the meeting, a relationship between the n participants and the m agenda items, and a weight value of each of the n participants.

17. The non-transitory storage medium according to claim 16, wherein the first score value and the second score value is calculated using a formula:
$$f = {\sum }_{j = 1}^{n} {I}_{j} * {C}_{j}^{2}$$
wherein, j represents each of the participants of the combination, n represents the total number of the participants included in the combination, Iⱼ represents the weight value of each of the participants, and Cⱼ represents a longest continuous duration of each of the participants participating the meeting.

18. The non-transitory storage medium according to claim 17, wherein the calculating of a second score value of each combination of X number of further processed combinations based on the meeting related information comprises:
setting the second score value of each combination of the X number of further processed combinations that meets a predetermined condition to be 0; and
calculating the second score value of each combination of the X number of further processed combinations that does not meet the predetermined condition, using the formula.

19. The non-transitory storage medium according to claim 18, wherein the predetermined condition comprises:
an order between two or more agenda items of the m agenda items of the combination is different from a predetermined order, arrangement time corresponding to a certain agenda item of the m agenda items of the combination is unavailable time of the participant participating the certain agenda item, and/or a combination thereof.

20. The non-transitory storage medium according to claim 16, wherein the method further comprising:
presetting a reference table, wherein the reference table defines personal information corresponding to a corresponding one of the weight values; and
determining the weight value of each of the n participants by searching the reference table according to personal information of each of the n participants.
